(19) United States
(12) Patent Application Publication
(10) Pub. No.: US 2009/0219016 A1
(43) Pub. Date: Sep. 3, 2009

(54) System for Detecting an Absolute Angular Position by Differential Comparison, Rolling Bearing and Rotary Machine

(76) Inventor: Franck Debrailly, Nouzilly (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/087,425

(22) PCT Filed: Jul. 3, 2007
(86) PCT No.: PCT/FR2007/000001

§ 371 Date: Feb. 3, 2009

(30) Foreign Application Priority Data
Jan. 6, 2006 (FR) 06/00120

(51) Int. Cl. G01B 7/30

(52) U.S. Cl. 324/207.25

(57) ABSTRACT

System for detecting angular position of a rotating element with respect to a non-rotating element, comprising an annular coder provided with a number P of poles greater than or equal to 2 intended to be fixed to one of the rotating or non-rotating elements and a number N of sensors, with N greater than or equal to 3, that are able to receive a signal originating from the coder and are mounted angularly distributed on the other of the rotating or non-rotating elements facing said rotating or non-rotating element and at least one subtraction module capable of processing at least two output signals from the sensors so as to generate a differential signal.

The present invention relates to the field of the detection of the angular position of a rotating element with respect to a non-rotating element. The present invention relates to the field of rotary systems in which it is desirable to ascertain the absolute angular position of a rotor with respect to a static element.

The abstract of document JP 2000-241197 describes a rotation detection device with three sensors mounted in proximity to one another.

The abstracts of documents JP 8-54205, JP 6-58770 and JP 2000-209889 describe a rotation detection device with three sensors.

Documents DE 39 10 498, U.S. Pat. No. 5,198,738 and U.S. Pat. No. 6,310,450 are aimed at sensors for brushless motors.

Document FR 2 599 794 relates to a roller bearing with magnetic information sensors with an annulus with a large number of poles.

Document U.S. Pat. No. 6,288,533 describes a method for determining the rotational position of a rotor carrying a magnetic source creating a magnetic field without rotational symmetry. The detection means comprise two detector pairs, the detectors of each pair being sensitive to the substantially parallel components of the magnetic field.

Such devices turn out in general to be complex and they generate signals which have to be processed by expensive means. The signal provided is sensitive to the variations in the air gap.

The present invention is aimed at remedying the drawbacks of the devices mentioned above.

The present invention is aimed at a simple detection system that is almost insensitive to the amplitude variations of the magnetic signal, and to the shifts due to mounting or to voltage variations.

A system for detecting angular position of a rotating element with respect to a non-rotating element, comprises an annular coder provided with a number P of poles greater than or equal to 2 intended to be fixed to one of the rotating or non-rotating elements and a number N of sensors, with N odd and greater than or equal to 3, that are able to receive a signal originating from the coder and are mounted angularly distributed on the other of the rotating or non-rotating elements facing said rotating or non-rotating element and at least one subtraction module capable of processing at least two output signals from the sensors so as to generate a differential signal.

The system can be trisensor or hexasensor. The coder can comprise two poles. The coder can be bipolar with 180° poles.

Advantageously, N is equal to 3, 5 or 7.

In an embodiment, the subtraction module comprises a calculation module capable by weighted differentiation of the signals of generating an output voltage Us=Sum(aᵢ*Uᵢ)−Sum(bᵢ*Uᵢ) with i from 1 to N, the coefficients aᵢ and bᵢ making it possible to recompose on the basis of N items of information the sine and the cosine of the angle sought.

In an embodiment, the subtraction module comprises a circuit for digitizing the analog items of information and an integrated circuit for calculating the output voltage.

In another embodiment, the subtraction module comprises an analog circuit for calculating the output voltage.

In an embodiment, the system comprises a bipolar annular coder intended to be fixed to the rotating element, three circumferentially regularly distributed magnetic field sensors intended to be fixed to the non-rotating element facing the coder, and the subtraction module receiving an output signal from each sensor, said signal being representative of the magnetic field measured by the sensor, and emitting as output a differential signal representative of the angular position θ of the rotating element with respect to the non-rotating element.

In an embodiment, the output signal from the calculation module comprises a sine signal and a cosine signal of the angular position θ of the rotating element with respect to the non-rotating element. It is then possible to calculate the angular position by a function of Arctangent type.

In an embodiment, the subtraction module comprises amplifiers mounted as a summator and/or subtracter.

In an embodiment, a first amplifier is mounted as a subtracter to provide a first output signal, a second amplifier is mounted as a summator-inverter and a third amplifier is mounted as a summator to provide a second output signal, the output of the second amplifier being linked to an input of the third amplifier. The subassembly comprising the amplifiers can be embodied in an economic manner by an analog circuit.

In an embodiment, the subtraction module comprises one filter per sensor, three amplifiers mounted at the output of the filters and an interpolator mounted at the output of the amplifiers. The interpolator can be of analog or digital type.

In an embodiment, denoting by B₁, B₂ and B₃ the output signals from the sensors, the calculation module when operating provides a first output signal equal to (√3/2)(B₂−B₃)/A and a second output signal equal to (B₁−(B₂+B₃)/2)/A, A being a constant.

In an embodiment, the subtraction module comprises an interpolator receiving the sine and the cosine of said angular position as input and providing said angular position θ as output.

In an embodiment, the sensors are distributed in a non-periodic manner so as to optimize the errors related to the shape emitted by the emitting annular race.

In an embodiment, the sensors are disposed in one and the same housing.

In an embodiment, the system comprises a rotation ratio mechanical reduction gear.

In an embodiment, the system comprises a mechanical counter incremented by one notch each revolution.

In an embodiment, the system comprises three sensors disposed over an angular sector of 2π/3, and a bipolar coder.

In an embodiment, the system comprises three sensors disposed over an angular sector of π/3 and a quadripolar coder.

In an embodiment, the system comprises three sensors disposed over an angular sector of 4π/9 and a hexapolar coder.

In an embodiment, the system comprises three sensors disposed over an angular sector of π/6 and an octopolar coder.

A roller bearing can comprise two races, a row of rolling elements disposed between the races and a detection system, said system providing the angular position of one race with respect to the other race.

A rotating machine, such as an electric motor, can comprise a rotor, a stator and a detection system, said system providing the angular position of the rotor with respect to the stator.

By virtue of the invention, the position detection is performed in a reliable manner that is almost insensitive to outside perturbations.

The present invention will be better understood on studying the detailed description of a few embodiments taken by way of wholly nonlimiting examples and illustrated by the appended drawings, in which:

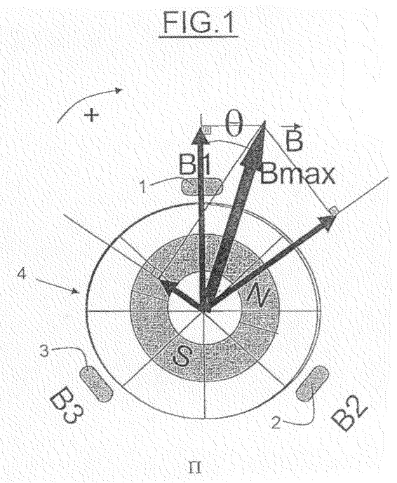

FIG. 1 is a schematic view in transverse section of a detection system;

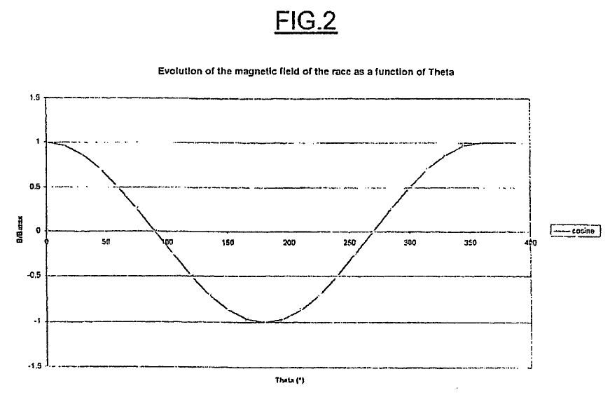

FIG. 2 is a curve of evolution of the magnetic field seen by a sensor as a function of the angle;

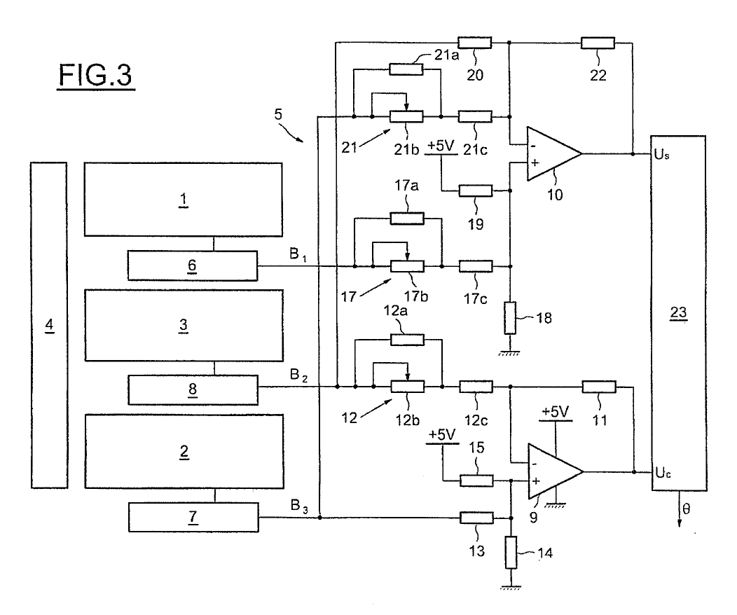

FIG. 3 is a schematic view of an electronic processing circuit;

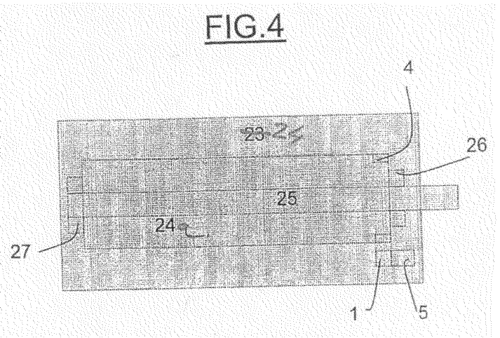

FIG. 4 is a schematic view in axial section of an electric motor;

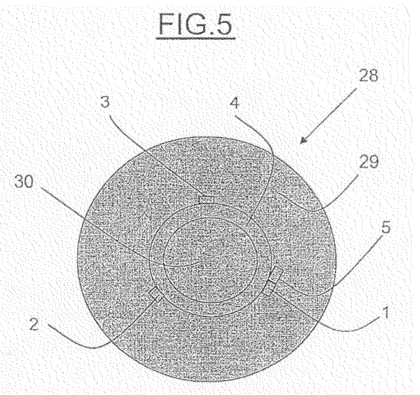

FIG. 5 is a schematic view in transverse section of a bearing;

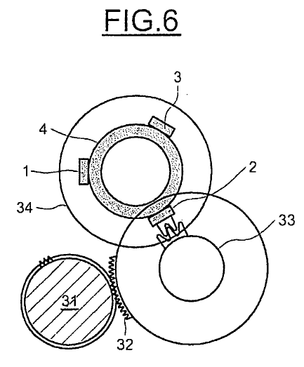

FIG. 6 is a schematic view from above of a detection assembly;

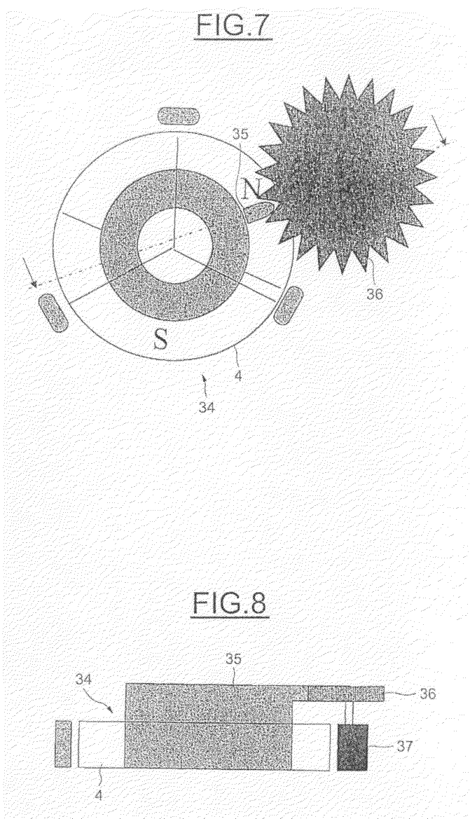

FIG. 7 is a view from above of a revolution counting system for the assembly of FIG. 6;

FIG. 8 is a view in section along VIII-VIII of FIG. 7;

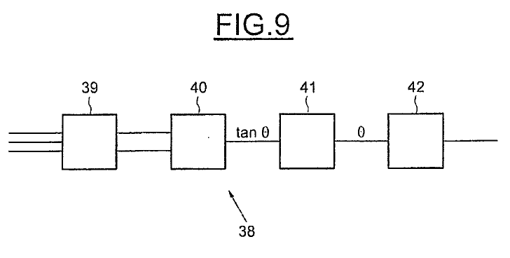

FIG. 9 is a schematic view of an electronic processing circuit;

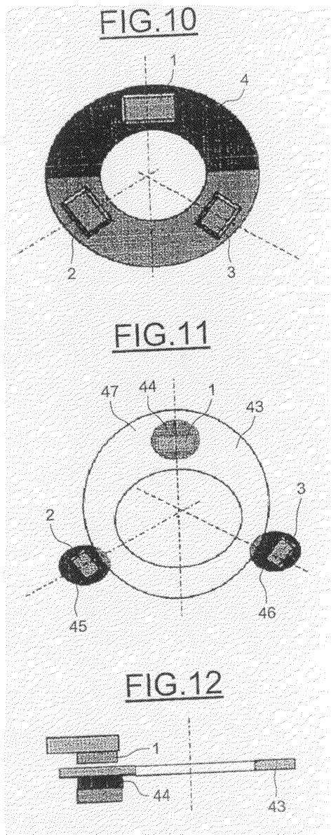

FIG. 10 is a schematic view from above of a detection system;

FIG. 11 is a schematic view from above of a detection system;

FIG. 12 is a schematic view in section of the detection system of FIG. 11;

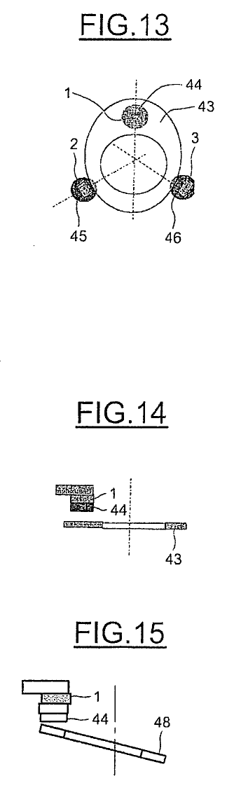

FIG. 13 is a schematic view from above of a detection system;

FIG. 14 is a schematic view in section of the detection system of FIG. 13;

FIG. 15 is a schematic view in section of a detection system;

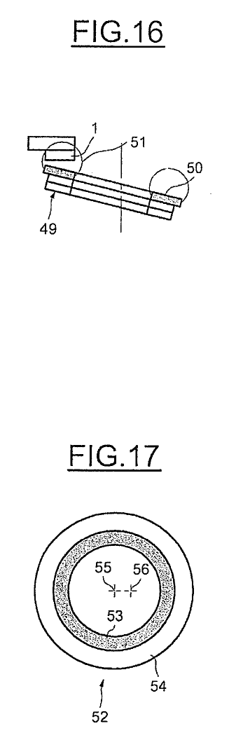

FIG. 16 is a schematic view of a detection system;

FIG. 17 is a schematic view from above of a detection system.

As illustrated by way of example in FIG. 1, the detection system comprises three magnetic field sensors 1, 2, 3, for example Hall-effect probes regularly distributed circumferentially around a coder annulus 4.

The coder annulus 4 comprises a North pole occupying an angular sector of 180° and a South pole occupying an angular sector of 180° and can rotate with respect to the sensors 1 to 3. The precision obtained in the event of a magnetic signal that is deformed with respect to a sinusoidal signal, for example a triangular magnetic signal, may be 1.2°. It is possible to employ five sensors for a precision of 0.3°. N=7 offers still better precision. In the case of N=4, the precision is only about 4°. The precision obtained with N=5 is greater than that which would be obtained with N=8. An odd number of sensors allows better recomposition of the signal, in particular through improved suppression of the harmonics, in particular of the harmonics due to a deformation of the signal which tends to become more triangular.

The coder annulus can be made by magnetizing a magnetic alloy or else a plasto-ferrite or an elasto-ferrite. The magnetic field B̅ exhibits a constant modulus Bₘₐₓ to within outside perturbations and the orientation of the magnetic field depends on that of the coder 4. The sensor 1 detects the field B̅₁ of value Bₘₐₓ cos θ, θ being the angle between the angular position of the sensor 1 with respect to the center of rotation of the coder 4 and the field B̅. Stated otherwise, θ is the angle between two straight lines both passing through the center of rotation of the coder 4, one passing through the sensor 1, and the other passing through the center of the North pole of the coder 4. As a function of the angular position of the coder 4, the field B₁ evolves as illustrated in FIG. 2. The field B₁ is equal to Bₘₐₓ cos(θ+120°) and the field B₃ is equal to Bₘₐₓ cos(θ+240°). Generally, we have Bᵢ/Bₘₐₓ=cos(2π(i−1)/3+θ).

As may be seen in FIG. 3, the detection system comprises an electronic circuit 5 for shaping the results of the measurement. The output of each sensor 1 to 3 is linked to a filter 6 to 8, making it possible to provide a detected magnetic field signal. The electronic circuit 5 comprises, in addition to the filters 6 to 8, two amplifiers 9 and 10. The amplifier 9 receives on its inverting input the signal B₃ originating from the filter 8 of the sensor 3 by way of a resistor 12. The resistor 12 comprises in series a fixed resistor 12c and a potentiometer 12b on the one hand, and in parallel with the potentiometer 12b, a fixed resistor 12a on the other hand. A resistor 11 is mounted between the inverting input and the output of the amplifier 9.

On its non-inverting input, the amplifier 9 receives the signal B₂ originating from the filter 7 of the sensor 2 by way of a resistor 13. A resistor 14 is disposed, on the one hand, between the point common to the non-inverting input of the amplifier 9 and to the resistor 13 and, on the other hand, to a ground of the circuit. A resistor 15 is disposed, on the one hand, between the point common to the non-inverting input of the amplifier 9 and to the resistor 13 and, on the other hand, to a power supply of the circuit, for example +5v.

The amplifier 9 provides as output a voltage equal to the sine of the angle θ to within a constant. The amplifier 9 therefore effects the difference between the field B₂ and the field B₃.

The amplifier 10 comprises a non-inverting input which receives the signal B₁ originating from the filter 6 of the sensor 1 by way of a resistor 17. The resistor 17 comprises in series a fixed resistor 17a and a potentiometer 17b on the one hand, and in parallel with the potentiometer 17b, a fixed resistor 17c on the other hand. A resistor 11 is mounted between the inverting input and the output of the amplifier 9. A resistor 18 is disposed, on the one hand, between the point common to the non-inverting input of the amplifier 10 and to the resistor 17 and, on the other hand, to a ground of the circuit. A resistor 19 is disposed, on the one hand, between the point common to the non-inverting input of the amplifier 10 and to the resistor 17 and, on the other hand, to a power supply of the circuit, for example +5v.

The amplifier 10 comprises an inverting input receiving, on the one hand, the signal B₃ by way of a resistor 20 and, on the other hand, the signal B₂ by way of a resistor 21. The resistor 21 comprises in series a fixed resistor 21a and a potentiometer 21b on the one hand, and in parallel with the potentiometer 21b, a fixed resistor 21c on the other hand. A resistor 22 is mounted between the inverting input and the output of the amplifier 9.

The amplifier 10 effects the addition of the signal B₁ and of the inverse of the sum of the signals B₂ and B₃. The output signal from the amplifier 10 is equal to the cosine of the angle θ to within a constant. The sine θ and cosine θ signals, respectively output by the amplifier 9 and by the amplifier 10, are dispatched to an interpolator 23 configured to calculate tan θ, that is to say the division of the sine by the cosine and to apply an arc-tangent function so as to provide the angle θ as output. The following is obtained:

$$tan θ = - \frac{\frac{\sqrt{3}}{2} ( {B}_{2} - {B}_{3} )}{{B}_{1} - \frac{1}{2} ( {B}_{2} + {B}_{3} )}$$

In the general case with N sensors, while preserving the advantages of the intrinsic insensitivity to numerous uniform magnetic fields, to temperature variations, to shifts in offset and in gain of the coder, we have:

$$θ = - a tan [ \frac{{\sum }_{i = 1}^{i = N} B i * sin ( \frac{2 π}{N} * ( i - 1 ) )}{{\sum }_{i = 1}^{i = N} B i * cos ( \frac{2 π}{N} * ( i - 1 ) )} ]$$

The values of the resistors 12 to 22 are chosen so as to apply the multiplicative constants of the latter equations. An extremely simple and inexpensive electronic processing circuit is thus embodied, which can be embodied in an analog manner as has been represented with reference to FIG. 3, or else in a digital manner. The angle θ is thus calculated in a reliable manner while being insensitive to the variations of the modulus Bₘₐₓ of the magnetic field, as well as to initial shifts, in particular mechanical shifts.

The differential detection system, as illustrated in FIG. 3, can be applied to an electric motor illustrated in FIG. 4 and comprising a stator 24, and a rotor 24a mounted on a shaft 25 supported by bearings 26 and 27.

In FIG. 4, only the sensor 1 is visible, the sensors 2 and 3 disposed in the electric motor not being in the sectional plan. The circuit 5 is mounted in immediate proximity to the sensor 1. The sensors and the processing circuit 5 are supported by the stator 23, while the coder 4 is supported by the rotor 24.

In the embodiment illustrated in FIG. 5, the detection system is mounted in a roller bearing referenced 28 as a whole. The roller bearing 28 comprises an outer race 29 and an inner race 30 supporting the coder 4. The outer race 29 supports the sensors 1 to 3 and the processing circuit 5. The bearing 28 can be used in various applications, in particular to support an electric motor shaft and ascertain the position of the poles of a rotor with respect to the poles of a stator.

Stated otherwise, a device for differentially detecting the position of a rotating element with respect to an non-rotating element, can comprise a bipolar coder intended to be fixed to the rotating element, three, five or seven circumferentially regularly distributed magnetic field sensors, with an air gap with respect to the coder and intended to be fixed to the non-rotating element, and a calculation circuit receiving an output signal from each sensor, said signal being representative of the magnetic field measured by the sensor. The calculation module is configured to emit as output a signal representative of the angular position θ of the rotating element with respect to the non-rotating element. The calculation module can comprise a sub-assembly consisting of three amplifiers associated with resistors.

In the embodiment illustrated in FIG. 6, the detection system comprises a gearing of small diameter 31 tied to a rotating element, not represented, whose position one wishes to ascertain, a double gearing provided with a toothing of large diameter 32, meshing with the gearing of small diameter 31, and with a toothing of small diameter 33, and a gearing of large diameter 34 meshing with the toothing of small diameter 33 of the double gearing. The coder 4 is tied in rotation to the gearing of large diameter 34 and the sensors 1 to 3 are fixed. The gearings ensure a reduction equal to D₃₂D₃₄/D₃₁D₃₃ with Dᵢ the diameter of the gearing i, hence excellent measurement precision.

It may thus turn out to be useful to count the number of revolutions performed by the gearing of large diameter 34. As illustrated in FIGS. 7 and 8, the gearing of large diameter 34 comprises a stud 35 shifted axially with respect to the toothing and provided so as to cooperate with a toothed wheel 36 shifted axially with respect to the gearing of large diameter 34. During the rotation of the gearing of large diameter 34, the toothed wheel 36 is driven in an intermittent manner with each passage of the stud 35 in proximity. Each angular displacement of the toothed wheel 36 corresponds to a revolution of the gearing of large diameter 34, in one direction or in the other. The toothed wheel 36 is furnished with an angular displacement sensor 37 which can be of economic type with low resolution.

The electronic processing circuit 38, illustrated in FIG. 9, comprises an analog digital converter 39 receiving as input the output signals from the sensors 1 to 3, a calculation module 40 comprising an input linked to the output of the converter 39, in particular configured to perform a division for example of the signal sin θ by the signal cos θ to obtain tan θ as output, a calculation module 41 comprising an input linked to the output of the calculation module 40, in particular configured to perform the arc tangent operation and obtain the angle as output θ, and a shaping module 42 receiving the angle θ as input and applying a shaping, for example by pulse width modulation or by digital analog conversion. The electronic processing circuit 38 therefore ensures digital processing, this being desired in certain applications.

In the embodiment illustrated in FIG. 10, the detection system comprises three sensors 1 to 3 disposed with an axial air gap with respect to the bipolar coder 4. The radial proportions are defined by the coder 4 and are reduced with respect to the radial proportions of the system illustrated in FIG. 1. The sensors 1 to 3 are disposed radially between the two circles delimiting the coder 4.

In the embodiment illustrated in FIGS. 11 and 12, the detection system comprises three sensors 1 to 3 disposed with an axial air gap with respect to the coder 43 and three stationary permanent magnets 44, 45 and 46. The coder 43 comprises a plane plate of a magnetic, for example non-ferrous, material of elliptical periphery and drilled with an elliptical opening whose axis formed by the foci is perpendicular to the axis formed by the foci of the peripheral ellipse so as to form a radially relatively wide bulge 47. The periphery of the coder is centered on the rotation axis of the coder 43. The magnets 44, 45 and 46 are disposed on the opposite side of the coder 43 from the sensors 1 to 3 and facing the latter. Stated otherwise, an axial air gap is provided between the magnets 44, 45 and 46 and the sensors 1 to 3. The axial air gap is sufficient to allow the coder 43 to come between the magnets 44, 45 and 46 and the sensors 1 to 3.

In the angular position visible in FIGS. 11 and 12, the bulge 47 of the coder 43 is situated between the magnet 44 and the sensor 1, very greatly weakening the magnetic field perceived by the sensor 1. Conversely, the coder 43 is absent between the magnet 45 and the sensor 2 and between the magnet 46 and the sensor 3. The sensors 1 to 3 therefore provide signals analogous to those provided in the previous embodiments.

The embodiment illustrated in FIGS. 13 and 14 is akin to that of FIGS. 11 and 12, except that the magnets 44 to 46 and the sensors 1 to 3 are disposed on the same side of the coder 43. The coder 43 is thus capable of modifying the magnetic field perceived by the sensors 1 to 3 according to its angular position.

The embodiment illustrated in FIG. 15 is akin to that of FIGS. 13 and 14, except that the coder 48 is inclined with respect to its rotation axis. The coder 48 comprises a plane plate of magnetic, for example ferrous, material of circular periphery and drilled with a circular opening concentric with the periphery. During the rotation of the coder 48, the distance between the coder 48 and the sensors 1 to 3 varies sinusoidally. The coder 48 modifies the magnetic field perceived by the sensors 1 to 3 according to the angular position of said coder 48.

The embodiment illustrated in FIG. 16 is akin to that of FIG. 15, except that the coder 49 comprises an annular bipolar race 50, for example based on magnetized plastoferrite. The coder 49, inclined with respect to its rotation axis, moves cyclically towards and away from each sensor 1 to 3 and generates a magnetic field 51 whose perception by each sensor 1 to 3 depends on the distance separating them and therefore on the angular position of the coder 49.

In the embodiment illustrated in FIG. 17, the coder 52 comprises an annular bipolar race with radial magnetization. Stated otherwise, one of the poles 53 is formed on the bore of the coder and the other pole 54 on the periphery. The center 55 of the coder 52 is shifted radially with respect to the rotation axis 56. A sensor disposed with a radial air gap therefore sees a North pole or a South pole as a function of the angular position of the coder 52. The output signal from the sensors 1 to 3 is therefore representative of the angular position of the coder 52.

1. A system for detecting angular position of a rotating element with respect to a non-rotating element, characterized in that it comprises an annular coder provided with a number P of poles greater than or equal to 2 intended to be fixed to one of the rotating or non-rotating elements and a number N of sensors, with N odd and greater than or equal to 3, that are able to receive a signal originating from the coder and are mounted angularly distributed on the other of the rotating or non-rotating elements facing said rotating or non-rotating element and at least one subtraction module capable of processing at least two output signals from the sensors to generate a differential signal.

2. The system as claimed in claim 1, in which the subtraction module comprises a calculation module capable by weighted differentiation of the signals of generating U cos=Sum(aᵢ*Uᵢ)Sum(bᵢ*Uᵢ) with i from 1 to N, the coefficients aᵢ and bᵢ making it possible to recompose on the basis of N items of information the sine and the cosine of the angle sought.

3. The system as claimed in claim 2, in which the subtraction module comprises a circuit for digitizing the analog items of information and an integrated circuit for calculating U cos.

4. The system as claimed in claim 2, in which the subtraction module comprises an analog circuit for calculating U cos.

5. The system as claimed in claim 1, comprising a bipolar annular coder intended to be fixed to the rotating element, three circumferentially regularly distributed magnetic field sensors intended to be fixed to the non-rotating element facing the coder, and the subtraction module receiving an output signal from each sensor, said signal being representative of the magnetic field measured by the sensor, and emitting as output a differential signal representative of the angular position θ of the rotating element with respect to the non-rotating element.

6. The system as claimed in claim 1, in which the output signal from the calculation module comprises a sine signal and a cosine signal of the angular position θ of the rotating element with respect to the non-rotating element.

7. The system as claimed in claim 1, in which the subtraction module comprises amplifiers mounted as a summator and/or subtracter.

8. The system as claimed in claim 7, in which a first amplifier is mounted as a subtracter to provide a first output signal, a second amplifier is mounted as a summator-inverter and a third amplifier is mounted as a summator to provide a second output signal, the output of the second amplifier being linked to an input of the third amplifier.

9. The system as claimed in claim 7, in which the subtraction module comprises one filter per sensor, the amplifiers being mounted at the output of the filters and an interpolator mounted at the output of the amplifiers.

10. The system as claimed in claim 8, in which, denoting by B₁, B₂ and B₃ the output signals from the sensors, the calculation module when operating provides a first output signal equal to (√3/2)(B₂−B₃)/A and a second output signal equal to (B₁−(B₂−B₃)/2)/A, A being a constant.

11. The system as claimed in claim 1, in which the subtraction module comprises an interpolator receiving the sine and the cosine of said angular position as input and providing said angular position θ as output.

12. The system as claimed in claim 1, in which the sensors are distributed in a non-periodic manner so as to optimize the errors related to the shape emitted by the emitting annular race.

13. The system as claimed in claim 1, in which the sensors are disposed in one and the same housing.

14. The system as claimed in claim 1, comprising a rotation ratio mechanical reduction gear.

15. The system as claimed in claim 14, comprising a mechanical counter incremented by one notch each revolution.

16. The system as claimed in claim 1, comprising three, five or seven sensors disposed over an angular sector of 2π/3, and a bipolar coder.

17. The system as claimed in claim 1, comprising three, five or seven sensors disposed over an angular sector of π/3 and a quadripolar coder.

18. The system as claimed in claim 1, comprising three, five or seven sensors disposed over an angular sector of 4π/9 and a hexapolar coder.

19. The system as claimed in claim 1, comprising three, five or seven sensors disposed over an angular sector of π/6 and an octopolar coder.

20. A roller bearing comprising two races, a row of rolling elements disposed between the races and a system as claimed in claim 1, said system providing the angular position of one race with respect to the other race.

21. A rotating machine comprising a rotor, a stator and a system as claimed in claim 1, said system providing the angular position of the rotor with respect to the stator.

22. The system as claimed in claim 7, in which a first amplifier mounted as a subtractor receives the signals from two sensors so as to provide a first output signal corresponding to the sine of the angular position θ, a second amplifier mounted as a summator-inverter receiving the sum of the signals from said two sensors and the signal from a third sensor so as to provide a second output signal corresponding to the cosine of the angular position θ.
